(19) United States
(12) Patent Application Publication
(10) Pub. No.: US 2009/0041306 A1
(43) Pub. Date: Feb. 12, 2009

(54) Living Body Variable Measuring System with Wireless Internet Access and Biometric Authentication

(76) Inventor: Justin Y Kwong, Sandiego, CA (US)

Correspondence Address: JUSTIN KWONG, 4668 TERRAZA MAR MARVELOSA, SAN DIEGO, CA, 92130, US

(21) Appl. No.: 11/835,421

(22) Filed: Aug. 8, 2007

(51) Int. Cl. G06K 9/00

(52) U.S. Cl. 382/115

(57) ABSTRACT

A physiological data measurement and analysis system comprises: a central processing centre for receiving physiological data for at least one subject, analysing the data and generating physiological information related to improving the subject's physiological condition based on the analysed data; at least one satellite station for measuring and transmitting selected physiological data of at least one subject to the central processing centre and receiving the generated physiological information from the central processing centre; and a communications network for coupling the central processing centre to each satellite station.

### FIELD OF THE INVENTION

The invention relates to a physiological data and analysis system, and more particularly to an interactive physiological data measurement and analysis system.

### BACKGROUND OF THE INVENTION

Prior art methodology for measuring and analysing physiological data comprises the steps of manually measuring height, such as with a stadiometer, measuring neck and waist size, such as with a tape measure, measuring body weight, such as with a weight scale, and estimating the body fat and the body mass index of a subject based upon these measurements. Of course, a stadiometer, a tape measure and a weight scale are simple devices that do not interact, monitor or track physiological changes to a user based on diet or food intake. Moreover, these devices cannot analyse their measurement data for the specific need of the subject nor can they track such data over any specific period to allow the subject to ascertain the achievement of specific milestones or goals.

Furthermore, such equipment is incapable of storing measurement data for multiple subjects. For example, in a household, a school or a local health club environment, there may be multiple subjects that use such equipment for measuring physiological data. Accordingly, it is desirable to have a physiological measurement and analysis system usable by a number of subjects that indicates both current and previous measurement data available for each subject at a variety of different locations and analyses changes in such data to generate diet and exercise programmes to improve the physiological and nutritional state of each subject.

### SUMMARY OF THE INVENTION

The invention generally comprises a physiological data measurement and analysis system comprising: a central processing centre for receiving physiological data for at least one subject, analysing the data and generating physiological information related to improving the subject's physiological condition based on the analysed data; at least one satellite station for measuring and transmitting selected physiological data of at least one subject to the central processing centre and receiving the generated physiological information from the central processing centre; and a communications network for coupling the central processing centre to each satellite station.

### DESCRIPTION OF THE DRAWINGS

FIG. 1 is a high-level schematic diagram of a physiological data measurement and analysis system for measuring and physiological data for a subject at a satellite station, transferring it over a communication network to a central processing centre for analysis and transferring the analysis back to the subject at the satellite station over the communication network according to a possible embodiment the present invention.

FIG. 2 is a diagram of a detachable subject input unit for the physiological measurement and analysis system shown in FIG. 1 that comprises a biometric identification device, a subject input data device, and an electronic tape measure.

FIG. 3 is a representation of a first satellite station graphical interface that displays an interactive food pyramid for a subject according to a possible embodiment of the invention.

FIG. 4 is a representation of a second satellite station graphical interface that displays dietary and/or exercise suggestions and/or programmes for a subject according to a possible embodiment of the invention.

FIG. 5 is a representation of a third satellite station graphical interface that displays social network information according to a possible embodiment of the invention.

### DETAILED DESCRIPTION OF THE INVENTION

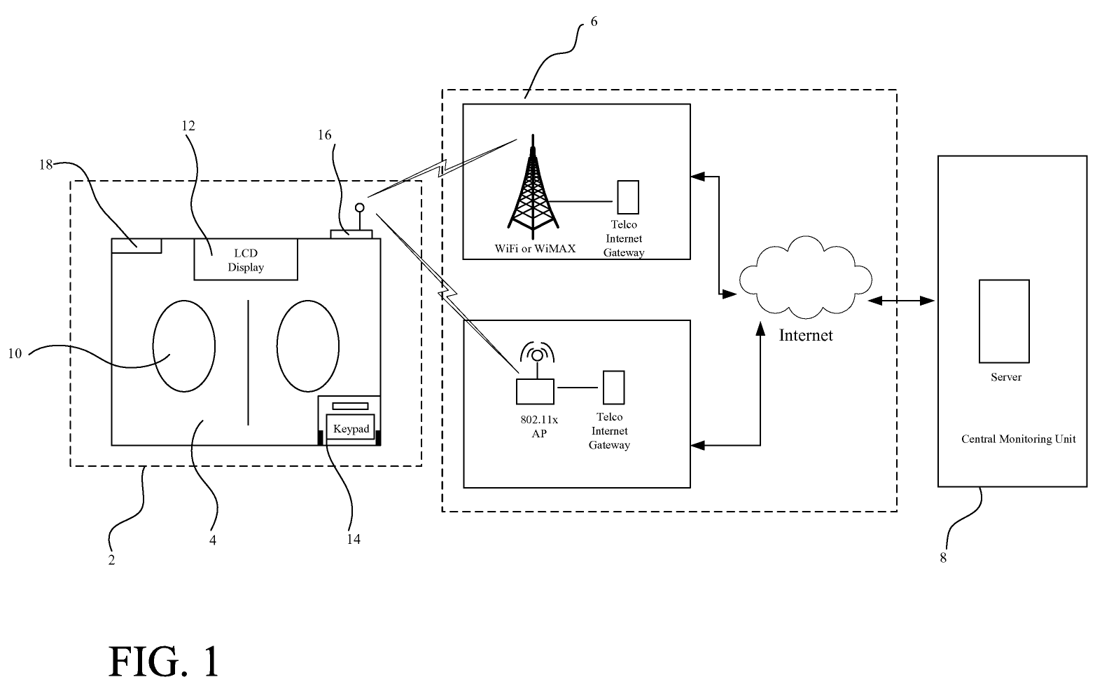

FIG. 1 is a high-level schematic diagram of a physiological data measurement and analysis system 2 for measuring physiological data for a subject at a satellite station 4, transferring it over a communication network 6 to a central processing centre 8 for analysis and transferring the analysis back to the subject at the satellite station 4 over the communication network 6 according to a possible embodiment the present invention. The satellite station 4 preferably comprises an electronic weight scale 10, a display 12, such as a liquid crystal display (LCD), a detachable subject input unit 14, a data communication transceiver 16 and optionally an electronic stadiometer 18.

The data communication transceiver 16 may conveniently comprise a modem, such as a digital signal line (DSL) or cable modem, or a wireless access point (WAP), such as a WAP that communicates according to IEEE 802.11 or 802.16 protocols. The communications network 6 typically comprises the Internet, but it may alternatively comprise a private communications network.

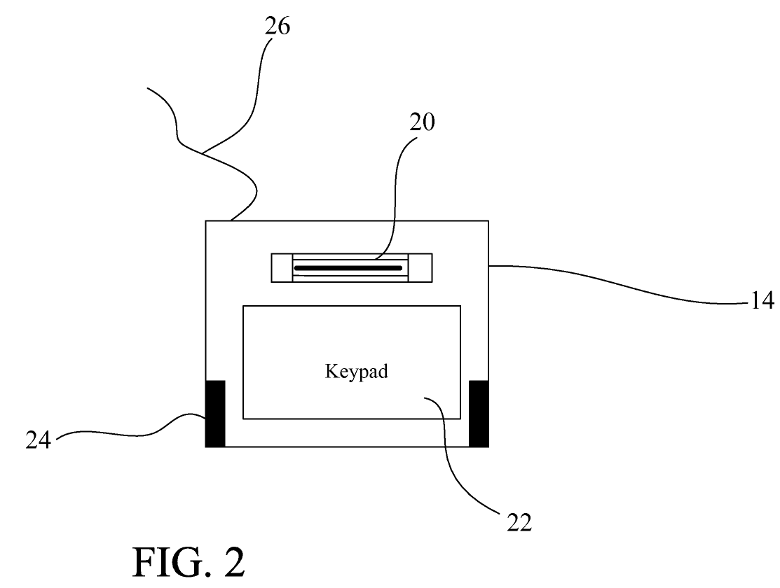

Referring to FIG. 2, the detachable subject input unit 14 comprises a biometric identity sensor 20, such as a finger print scanner, a data input device 22, such as a keypad, and an electronic tape measure 24. The detachable subject input unit 14 communicates with the remainder of the satellite station 4 by way of a communication path 26 that may be a wired or wireless signal path. A subject initiates a physiological data measurement and analysis procedure by letting the biometric identity sensor 20 identify the subject's identity. The satellite station 4 transfers this information through the communication network 6 to the central processing centre 8. The central processing centre 8 identifies and authenticates the subject based upon this data. The data input device 22 allows a subject to manually register for initial use or enter additional data, for instance, the subject's height, if the satellite station 4 lacks the optional electronic stadiometer 18, age and sex, and the satellite station 4 transfers this data through the communications network 6 to the central processing centre 8. The electronic tape measure 24 then measures the neck size and waist size for an estimation of body fat, and the satellite station 4 transfers this data through the communications network 6 to the central processing centre 8.

The central processing centre 8 analyses height, weight, neck size, waist size, age and sex information that it receives from the satellite station 4 by way of the communication network 6, as well as any such data from previous sessions, and generates corresponding suggestions and/or programmes for diet and exercise to improve the physiological condition of the subject.

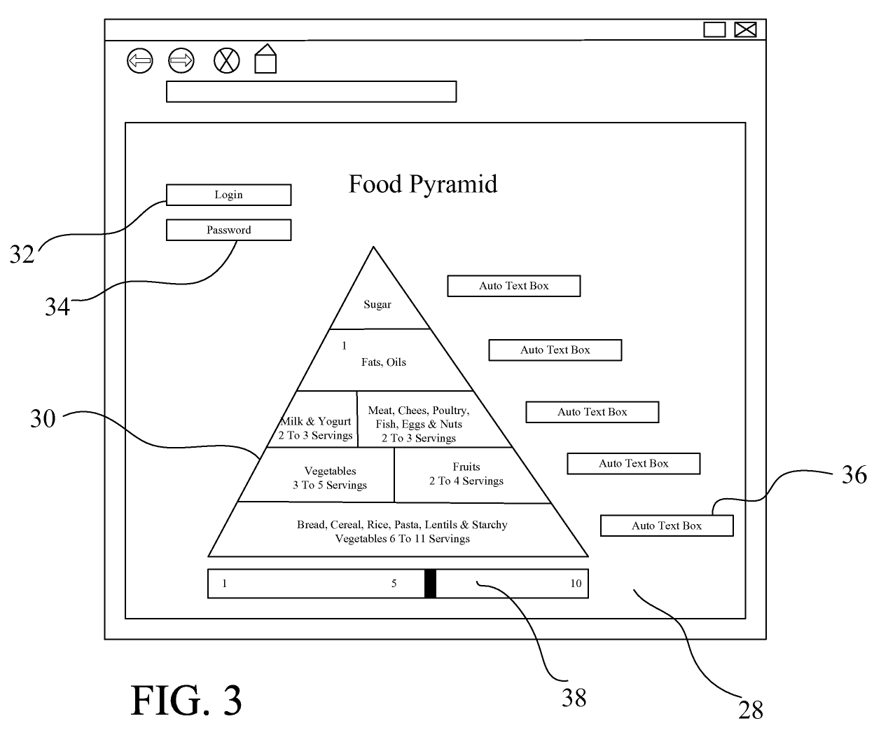

FIG. 3 is a representation of a first satellite station graphical interface 28 that displays an interactive food pyramid 30 for a subject according to a possible embodiment of the invention on the display 12 of the satellite station 4. This first interface 28 has a login field 32, a password field 34 for the subject to log in to the system 2 and multiple food consumption fields 36 for the subject to input food consumption. Each food consumption field 36 typically comprises an auto text box with a drop-down menu of suggestions for each type of food consumption. For this purpose, a database within the central processing centre 8 would contain a list of typical menu items a subject would eat at restaurants or at home. The central processing centre 8 would also allow the subject to customise a food item if the item is not in the database. The first satellite station graphical interface 28 may also show progress of the subject's goal in an advisory field 38.

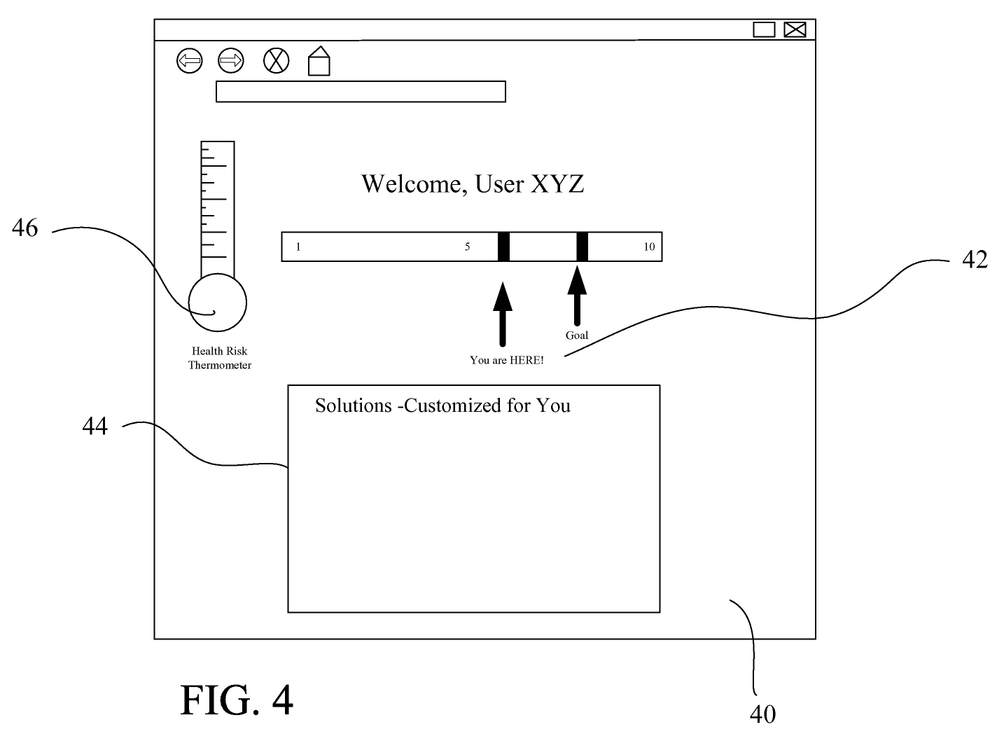

FIG. 4 is a representation of a second satellite station graphical interface 40 that displays dietary and/or exercise suggestions and/or programmes for a subject according to a possible embodiment of the invention. For instance, if the subject wishes recommendations and/or programmes to meet desired physiological targets as the user may enter in a physiological target field 42 and assesses the user's health risk with the health risk thermometer 46, the central processing centre 8 would analyse this data to offer a customised solution for the subject in a solutions field 44.

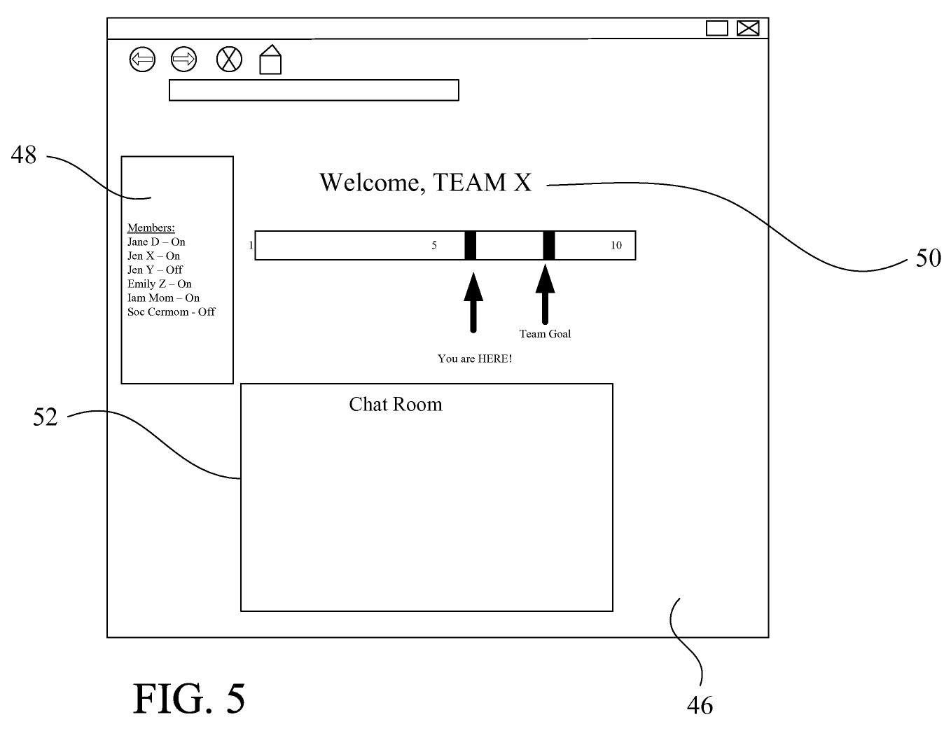

FIG. 5 is a representation of a third satellite station graphical interface 46 that displays social network information according to a possible embodiment of the invention. For instance, if the subject wishes to participate in a social group as shown in a social group field 48, it would allow the subject to interact with selected members as shown in an on-line members field 50 and chat with one another in a message field 52.

The described embodiment of the invention is only an illustrative implementation of the invention wherein changes and substitutions of the various parts and arrangement thereof are within the scope of the invention as set forth in the attached claims.

The claimed invention is:

1. A physiological data measurement and analysis system comprising:
a central processing centre for receiving physiological data for at least one subject, analysing the data and generating physiological information related to improving the subject's physiological condition based on the analysed data;
at least one satellite station for measuring and transmitting selected physiological data of at least one subject to the central processing centre and receiving the generated physiological information from the central processing centre; and
a communications network for coupling the central processing centre to each satellite station.

2. The system of claim 1, wherein the satellite station comprises an electronic weight scale, a display, a data communication transceiver, a biometric identity sensor, a data input device and an electronic tape measure.

3. The system of claim 2, wherein the satellite station further comprises an electronic stadiometer.

4. The system of claim 2, wherein the biometric identity sensor, the data input device and the electronic tape measure mount within a detachable subject input unit that communicates with the remainder of the satellite station by way of a communication path.

5. The system of claim 4, wherein the communication path is a wired path.

6. The system of claim 4, wherein the communication path is wireless path.

7. The system of claim 2, wherein the communications network is the Internet.

8. The system of claim 7, wherein the data communication transceiver is a digital signal line (DSL) modem.

9. The system of claim 7, wherein the data communication transceiver is a cable modem.

10. The system of claim 7, wherein the data communication transceiver is a wireless access point (WAP).

11. The system of claim 10, wherein the WAP communicates in accordance with the IEEE 802.11 protocol.

12. The system of claim 10, wherein the WAP communicates in accordance with the IEEE 802.16 protocol.

13. The system of claim 1, wherein the central processing centre stores previous subject physiological data and analyses both previous and current physiological data to generate the physiological information.

14. The system of claim 1, wherein the generated physiological information comprises recommendations for the subject's diet.

15. The system of claim 1, wherein the generated physiological information comprises recommendations for the subject's exercise.

16. A method of measuring and analysing physiological data, comprising the steps of:
measuring selected physiological data of at least one subject in at least one satellite location;
transmitting the measured physiological data to a central location remote from each satellite location;
analysing the measured physiological data;
generating physiological information related to improving the subject's physiological condition based on the analysed data; and
transmitting the generated physiological data to the satellite location for display to the subject.

17. The method of claim 16, wherein the generated physiological information comprises recommendations for the subject's diet.

18. The method of claim 16, wherein the generated physiological information comprises recommendations for the subject's exercise.
